(19) United States
(12) Patent Application Publication
(10) Pub. No.: US 2015/0081519 A1
(43) Pub. Date: Mar. 19, 2015

(54) DYNAMIC PRICING FOR FINANCIAL PRODUCTS

(71) Applicant: International Business Machines Corporation, Armonk, NY (US)

(72) Inventors: JoAnn P. Brereton, Hawthorne, NY (US); Arun Hampapur, Norwalk, CT (US); Hongfei Li, Briarcliff Manor, NY (US); Robin Lougee, Yorktown Heights, NY (US); Buyue Qian, Sacramento, CA (US)

(73) Assignee: International Business Machines Corporation, Armonk, NY (US)

(21) Appl. No.: 14/169,394

(22) Filed: Jan. 31, 2014

Related U.S. Application Data
(63) Continuation of application No. 14/027,453, filed on Sep. 16, 2013.

(51) Int. Cl. G06Q 40/02

(52) U.S. Cl. CPC G06Q 40/025
USPC 705/38

(57) ABSTRACT

An aspect of product pricing includes classifying customers into groups based on shared, predefined characteristics and financial transactions, and identifying services rendered and available but not rendered. For each customer, a risk associated with a service is estimated; availability and prices of the service by third parties are determined; a price for the service set by the entity is compared with the prices set by the third parties; and a demand for the service of the entity is estimated as a function of the availability and prices of the service by the third parties. For each customer, a probability that the customer will purchase the service is estimated based on the demand, and a price for the service that is customized for the customer is calculated, as a function of the risk, the demand, and the probability of purchase, and in view of a target profit and/or target revenue.

### CROSS-REFERENCE TO RELATED APPLICATION

This application is a continuation of U.S. patent application Ser. No. 14/027,453, filed Sep. 16, 2013, the disclosure of which is incorporated by reference herein in its entirety.

### BACKGROUND

The present invention relates to financial services and, more specifically, to real-time dynamic product pricing of financial products and services.

With the exception of a few high value banking products, such as home mortgages and auto loans, the pricing of most banking products and services are static in that fees for the services are generally fixed or within some defined fixed range with the ultimate goal of minimizing risks and maximizing profits. However, customers do not necessarily fit a once-size-fits-all model when evaluating factors such as their ability to pay for a product or service and the overall likelihood of default. As a result, the fixed fee pricing model may seem inappropriate or unfair to certain customers. For example, it may be undesirable to charge a customer, who has promptly and unwaveringly made all payments on a loan, the same fees as charged to another customer, who is sporadic on repayment of a loan.

### SUMMARY

According to one embodiment of the present invention, a method is provided. The method includes classifying, by a computer processor, customers of an entity into groups based on commonly shared, predefined characteristics and common financial transaction activities conducted among the customers. The method also includes identifying services rendered to the customers and services available but not rendered to the customers. For each customer in each of the groups, the method includes estimating a risk value associated with providing a service based on results of providing the service to other customers in the group; determining availability of the service, and prices set for the service, by third-party entities; comparing a price for the service set by the entity with the prices set by the third-party entities; and estimating a demand value for the service of the entity as a function of the availability of the service by the third-party entities and the prices set by the third-party entities for the service. For each customer in each of the groups, the method includes estimating a probability that the customer will purchase the service based on the demand value, and calculating a price for the service that is customized for the customer, as a function of the risk value, the demand value, and the probability of purchase, and in view of at least one of a target profit value and a target revenue value.

According to another embodiment of the present invention, a system is provided. The system includes a computer processing system and an application executable by the computer processing system. The application is configured to implement a method. The method includes classifying customers of an entity into groups based on commonly shared, predefined characteristics and common financial transaction activities conducted among the customers. The method also includes identifying services rendered to the customers and services available but not rendered to the customers. For each customer in each of the groups, the method includes estimating a risk value associated with providing a service based on results of providing the service to other customers in the group; determining availability of the service, and prices set for the service, by third-party entities; comparing a price for the service set by the entity with the prices set by the third-party entities; and estimating a demand value for the service of the entity as a function of the availability of the service by the third-party entities and the prices set by the third-party entities for the service. For each customer in each of the groups, the method includes estimating a probability that the customer will purchase the service based on the demand value, and calculating a price for the service that is customized for the customer, as a function of the risk value, the demand value, and the probability of purchase, and in view of at least one of a target profit value and a target revenue value.

According to a further embodiment of the present invention, a computer program product is provided. The computer program product includes a storage medium embodied with machine-readable program instructions, which when executed by a computer causes the computer to implement a method. The method includes classifying customers of an entity into groups based on commonly shared, predefined characteristics and common financial transaction activities conducted among the customers. The method also includes identifying services rendered to the customers and services available but not rendered to the customers. For each customer in each of the groups, the method includes estimating a risk value associated with providing a service based on results of providing the service to other customers in the group; determining availability of the service, and prices set for the service, by third-party entities; comparing a price for the service set by the entity with the prices set by the third-party entities; and estimating a demand value for the service of the entity as a function of the availability of the service by the third-party entities and the prices set by the third-party entities for the service. For each customer in each of the groups, the method includes estimating a probability that the customer will purchase the service based on the demand value, and calculating a price for the service that is customized for the customer, as a function of the risk value, the demand value, and the probability of purchase, and in view of at least one of a target profit value and a target revenue value.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a block diagram of a system upon which product pricing optimization processes may be implemented according to an embodiment of the present invention;

FIG. 2 depicts a flow diagram describing a process for implementing optimized product pricing according to an embodiment of the present invention; and

FIG. 3 depicts a data flow diagram for implementing product pricing optimization according to an embodiment of the present invention.

### DETAILED DESCRIPTION

Exemplary embodiments provide optimization of product pricing for financial products and services (collectively referred to herein as “services”). The products and services may include, e.g., wealth management, checking and savings accounts, credit cards, wire and transfer services, merchant services, currencies exchange, and asset financing, to name a few. The embodiments include segmenting a customer base into groups of customers, whereby each group consists of customers having the same or similar predefined characteristics. The embodiments include evaluating customer profiles and historical data collected on customer banking activities and transactions, in view of externally acquired information, such as third party product pricing and real-time market information, and applying this information to a set of business rules that account for a financial institution's desired profits and/or revenues and risk tolerances to determine price points for providing services to customers. In this manner, each customer may conceivably be charged a different price for the same product. These and other features of the product pricing optimization processes will now be described.

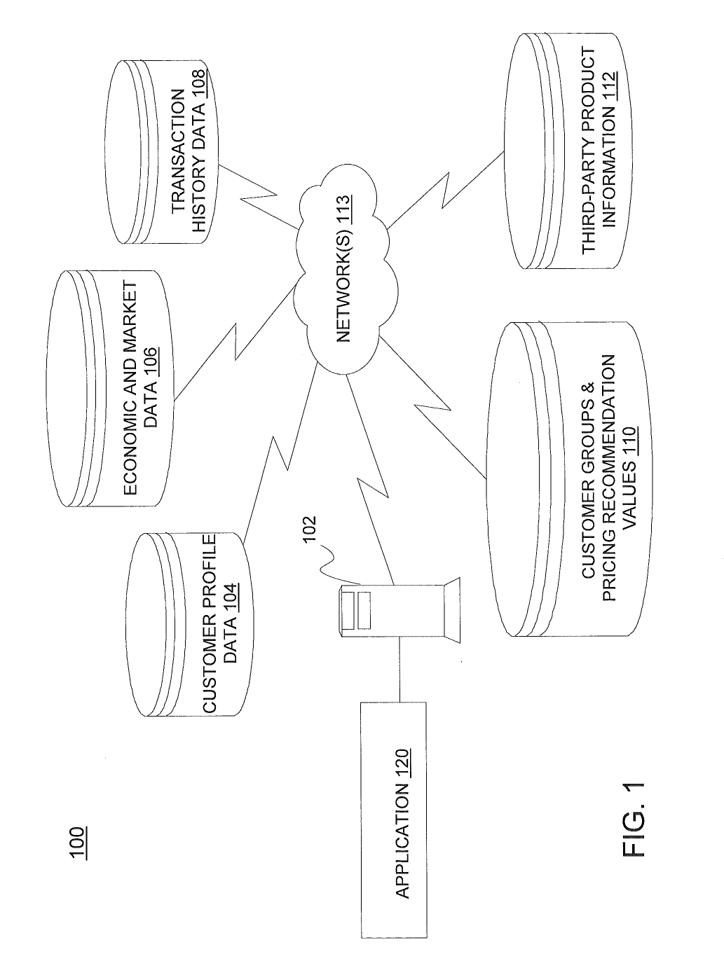

Turning now to FIG. 1, a system 100 upon which the product pricing optimization processes may be implemented will now be described in an exemplary embodiment. The system 100 of FIG. 1 includes a host system 102 in communication with various data sources 104-112 over one or more networks 113.

The host system 102 may be implemented as a high-speed computer processing device (e.g., a mainframe computer) that is capable of handling a large volume of data received from the data sources 104-112. The host system 102 may be implemented by any entity or enterprise that collects and processes a large amount of data from a multitude of data sources (e.g., data sources 104-112) to manage, or may be offered as a service to such entity by, e.g., an application service provider (ASP). In an embodiment, the host system 102 is implemented by a financial institution that offers various financial-related services to its customers, such as credit account offerings and savings account offerings, investment products, and mortgage products, as well as various differing terms, such as transaction risk daily limits, interest rates, and penalties.

The data sources 104-112 are implemented as data storage devices that are configured to receive and store information for access by computer systems, such as the host system 102. In FIG. 1, these data sources 104-112 are shown as individual data storage devices; however, it will be understood that fewer or greater numbers of storage devices may be employed (e.g., data stored in two or more data sources may be integrated into a single storage device) in realizing the advantages of the embodiments described herein. In addition, while shown in FIG. 1 as being coupled to the host system 102 through networks 113, it will be understood that one or more of the data sources 104-112 may be directly in communication with the host system 102 (e.g., via cabling). Alternatively, one or more of the data sources 104-112 may be logically addressable by the host system 102, e.g., as a consolidated data source over one or more of the networks 113.

In particular, the data sources include a storage device 104 that stores customer profile data, a storage device 106 that stores economic and market data, a storage device 108 that stores transaction history data, a storage device 110 that stores customer groups and product pricing values, and a storage device 112 that stores product pricing information for a third-party financial institution (e.g., a competitor of the host system 102 enterprise). It will be understood that multiple data sources, particularly with regard to the economic and market data, as well as the third-party financial institution data, will likely be used and accessed in implementing the exemplary processes described herein.

Customer profile data may include information derived from customer accounts stored and managed by the host system 102. For example, customer profile data may include customer type (e.g., business, personal consumer, for-profit, non-profit, charitable, etc.), customer geographic location(s), number of employees, annual revenue, industry of customer business (e.g., manufacturing, retail, health care, insurance, etc.), length of employment, assets owned, and customer age. Customer profile data may be used to determine similarities among various customers of the entity associated with the host system 102. The customer profile data may be used to define characteristics as a foundation to group customers that share similar traits. For example, one characteristic may be the size of the customer in terms of the number of employees and/or the annual revenue generated by the customer. Another characteristic may be type of business the customer is engaged in. The characteristics may be customized by an administrator of the product pricing recommendation processes, if desired.

Economic and market data include economic health of the particular customer as a personal consumer and/or a business enterprise, the economic health of the region in which the customer operates (as a business) or resides (as a consumer), the economic health of the industry in which the customer operates, and/or the current health of the national or global market as a whole. Economic health data may be obtained for a particular customer in part, e.g., from an annual financial report published by the customer or credit scores obtained from a credit report. Economic health information about a region, industry, etc. of the market may be obtained, e.g., from the stock market, current interest rates, industry news reports, etc. It will be understood by those skilled in the art that some of the economic health data may be derived from sources internal to the entity of the host system 102 (e.g., from financial account information, such as account balances, available credit, etc., from storage device 104). In this manner, the economic health data associated with a customer may be included in the customer profile data described above.

The economic health of a particular customer, region of the customer, and industry of the customer may be used, similar to the customer profile data, to group customers that share similar economic health traits. The health of the market as a whole can also be used in implementing the product pricing optimization processes described herein. For example, in a healthy market, additional services (or services having more customer-favored terms) may be offered to more of the customers of the enterprise, as compared to what may be offered in a lean market.

Transaction history data includes historical information about the transactions conducted between the customer and the entity and/or other enterprises. For example, transaction history data may include frequency of transactions, a frequency and dates of transactions involving a customer's daily limits (cash or credit), any defaults that may have occurred and the dates of the defaults, and average dollar amount of transactions over a period of time. Transactions may also include investment activity and loan activity. The transactions may relate to financial accounts associated with checking, savings, money market, CDs, mortgages, asset acquisition, lease, and/or and sale, etc., and may include deposits, withdrawals, credit purchases, cash purchases, loans, and investments.

Customer groups and pricing recommendation values include information derived from processing the customer profile data, economic health data, transaction history data, and third-party data. The customer groups refer to the classification or segmentation of the customers based on the above-referenced characteristics and information. For example, one group may include all manufacturing-based customers with a size of 500 or more employees. Groups may be further drilled down more granularly, e.g., a group consisting of all manufacturing-based customers with a size of 50-150 employees and having U.S. facilities in the Northeast. The pricing recommendation values are derived from analyses of the expected risks of providing a service, the estimated demand for the service, and the probability of acceptance of the service by customers.

Product pricing information for third-party financial institutions includes fees, costs, etc. set by the third parties for like or similar products and services.

Turning back to FIG. 1, the networks 113 may include any type of networks, such as local area networks, wide area networks, virtual private networks, and the Internet. In addition, the networks 113 may be configured to support wireless communications, e.g., via radio frequency (RF) communications, cellular networks, satellite networks, and global positioning (GPS) systems.

The host system 102 executes an application 120 for implementing the exemplary product pricing optimization processes, as described herein.

As indicated above, in an embodiment, the product pricing optimization processes (e.g., via the application 120) may also include a user interface component for enabling authorized users to customize customer profile characteristics, business rules and/or threshold values used in the product pricing optimization processes described herein.

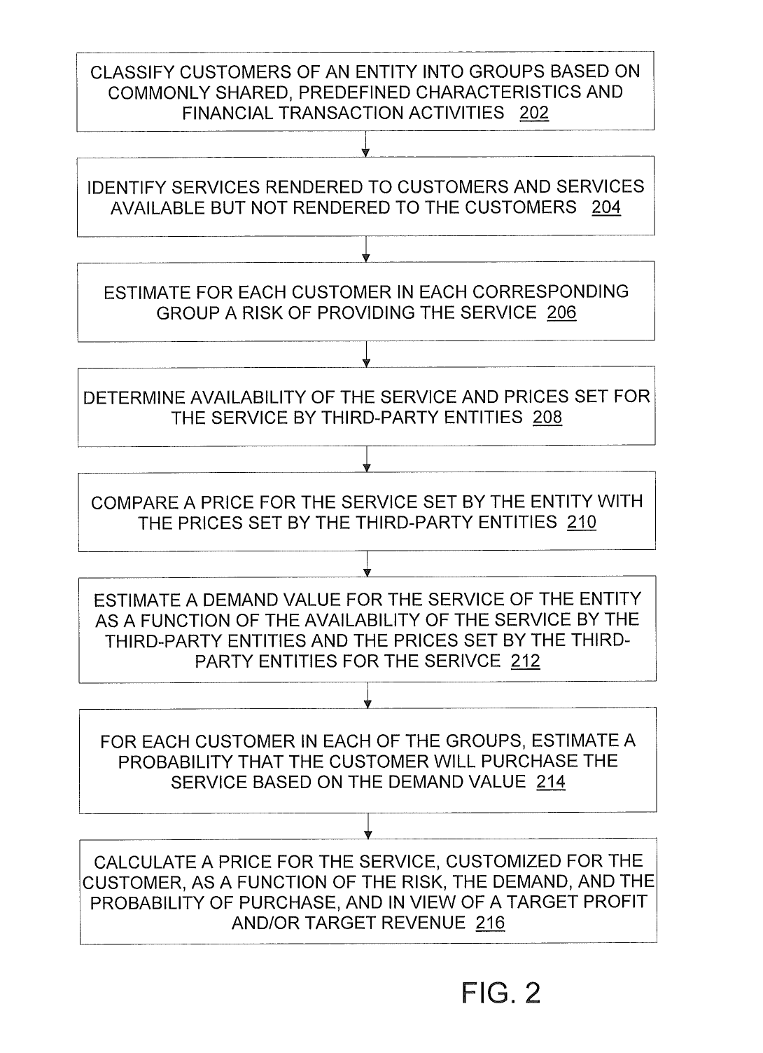

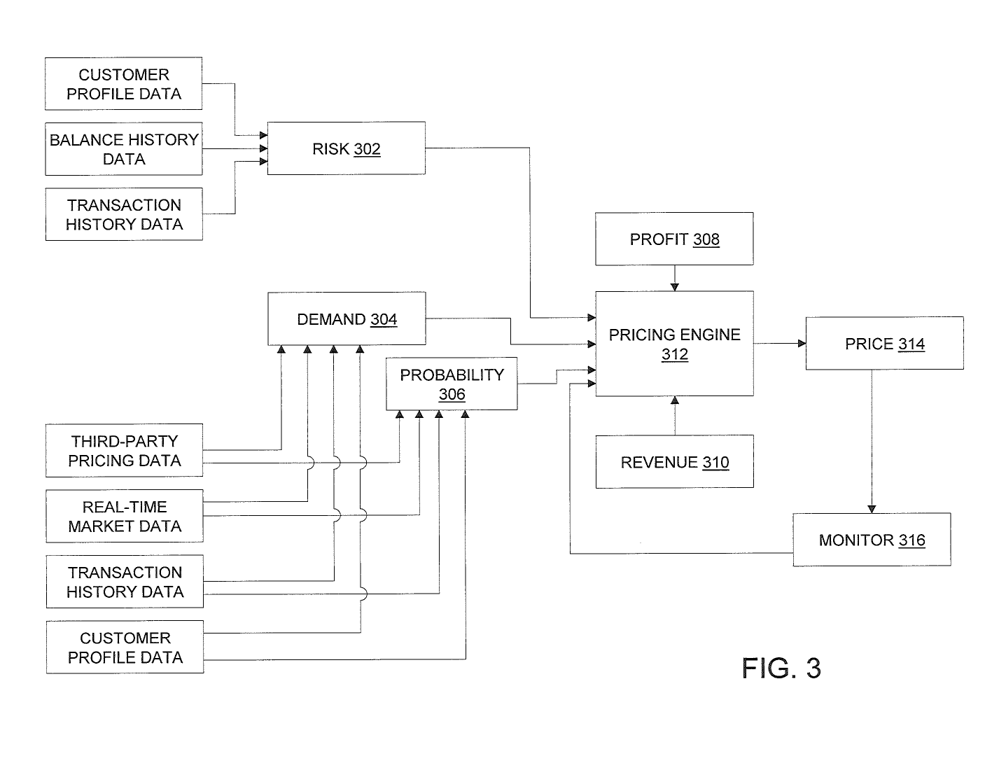

Turning now to FIGS. 2 and 3, a flow diagram and data flow diagram describing a process for implementing product pricing optimization will now be described in an exemplary embodiment.

At step 202, customers that have an established history of business interactions with the entity or financial enterprise of the host system 102 are classified into groups via the application 120 based on commonly-shared, predefined characteristics from collected customer profile data (from storage device 104). In addition to the customer profile data, the application 120 factors in the economic health of the customer, region in which the customer is located, industry in which the customer works, or the economic health of the market itself (from storage device 106). Further, the application 120 factors in transaction history data in grouping the customers (from storage device 108). By way of example, economic health data may include a customer account balance, an available credit balance, a credit score, customer ownership of assets, and length of employment, to name a few.

Grouping the customers by predefined characteristics can provide advantages to the enterprise of host system 102, particularly if the entity services a multitude of customers. For example, a large financial banking enterprise having a million or more customers would find it difficult to identify which customers to offer a given service. In the embodiments described herein, the product pricing optimization processes enable the enterprise to group like or similar customers into groups to render them more manageable in assessing service offerings.

Turning back to FIG. 2, the application 120 identifies services rendered to customers and also services available (e.g., offered) by the entity but not rendered for the customers at step 204. In an embodiment, the application 120 filters each of the customers profile data in the group according to the services provided and determines which services are not currently implemented for respective customers. A list of customers and their services may be generated and compared against a master list of services to derive this information.

At step 206, the application 120 estimates, for each customer in group, a risk of providing the service. The risk of loss may be based on certain circumstances, such as customer default on a loan or credit account, non-use of a financial product (e.g., an open but unused account), unexpected market fluctuations, etc. Thus, in step 206, the application 120 estimates a transaction risk for the customer for a particular service, which may be based on known results of offering the service to similar customers in the group. For example, a credit line account of $50,000 may be considered a high risk for a customer of one group (where the customers of the group generally demonstrate a greater incidence of default for similar accounts), and an acceptable risk for a customer of another group (in which the customers of that group generally demonstrate a low incidence of default for similar accounts). Thus, using the transaction history data of customers in the group shared by the customer under evaluation, the application 120 determines an expectation of the risk involved. Implementing high risk services are likely to result in greater losses for the entity. Thus, the application 120 may collectively evaluate the transaction risk (e.g., determine an average) across all customers in the group, as well as for each of the groups.

As shown in FIG. 3, customer profile data from storage device 104, balance history data and transaction history data from storage device 106 is used by the application 120 to estimate a risk 302. The risk may be quantified as a value, e.g., a percentage of risk, whereby a risk value of 100% represents a greatest amount of risk.

Thus, as indicated above, the application 120 analyzes the risk relationships between the customers for each group and the service offered in view of the corresponding transaction histories and account balances. For example, using the risk value as a percentage, it may be determined from the analysis that 44 percent of customers in a first group have never been in a default status for a particular service provided to the customers. Further, it is determined that another 38 percent have been in default once over the life of the service provided. Based on target risk percentages or range values adopted by the enterprise, these risks may have a positive or negative effect on the ultimate product pricing decision, as described further herein.

At step 208, the application 120 determines availability of the service and prices set for the service by third-party entities (e.g., competitors of the entity). For example, a service is that offered by very few competitors may mean that there is expected to be a potentially greater demand for the service offered by the entity.

At step 210, the application 120 compares a price for the service set by the entity with the prices set by the third-party entities. By knowing the prices set by third parties, the entity of the host system 102 is better able to understand where demand for the service it offers may fall regarding its customers. For example, if the prices set by third parties are generally higher than a target price estimated by the entity, this may mean that there is expected to be a potentially greater demand for the service offered by the entity.

At step 212, the application 120 estimates a demand value for the service of the entity as a function of the availability of the service by the third-party entities and the prices set by the third-party entities for the service. In an embodiment, the application 120 further estimates the demand value based on current economic health data, e.g., from the storage device 104 and/or the storage device 106, such as customer account balance, credit score, current state of the regional or national market, etc. By factoring in external economic health data, such as the current state of the market, the entity of the host system 102 may better understand whether the services are affordable for various customers, which in turn, may translate to demand.

As shown in FIG. 3, third-party data from storage device 112, real-time market data from storage device 106, transaction history data from storage device 108, and customer profile data from storage device 104, is used to estimate a demand 304 for a service. The demand may be represented as a value similar to that described above with respect to the risk.

At step 214, for each customer in each of the groups, the application 120 estimates a probability that the customer will purchase the service based on the demand value. In an embodiment, the application 120 considers the economic health data in determining the likelihood or probability that the customers in the group will accept the service if offered by the entity. Factors used in this determination may include, e.g., a customer's account balance, an available credit, ownership of assets, length of employment, etc. As can be seen, these factors point to a probability that the customer is financially capable of successfully using the service. In another example, a lack of ownership in an asset (home or car), or a length of time an asset has been held, can be useful in determining whether the customer is more likely to accept an offer, e.g., of a car loan or mortgage. In addition, this determination factors in third-party pricing data, real-time market data (e.g., health of the market), and customer profile data. In an embodiment, the determination also factors in the current economic health of the customer.

Determining the probability of acceptance is a useful step in the process as the probability of acceptance across a number of customers enables the entity to better estimate resulting profits from customers who accept the service.

As shown in FIG. 3, third-party pricing information from storage device 112, economic health information from storage device 106, transaction history data from storage device 108, and customer profile data from storage device 104 may be used to determine a probability of acceptance 306. The probability of acceptance may be represented as a value similar to that described above with respect to the risk.

At step 216, the application 120 calculates a price for the service, that is customized for the customer, as a function of the risk 302 (step 206), the demand 304 (step 212), and the probability of purchase 306 (step 214), and in view of a target profit and/or target revenue.

As shown in FIG. 3, the risk value 302, demand value 304, and probability of purchase 306 are processed by a pricing engine 312 of the application 120, along with a target profit value 308 and a target revenue value 310 to derive a recommended price 314 for the service to the customer.

For example, in one scenario it is assumed that the risk value of providing the service is low and the demand for the service is high, and the entity is more interested in profit than revenue, the pricing engine 312 may calculate a price of $100 for the service to meet the expected profit. In another scenario in which the risk is low and the demand is high, the entity is more interested in revenue than profit. The pricing engine 312 may set a price lower than $100 to entice more customers to buy the service despite the fact that the profit may be lower. In a similar scenario where the risk is low, the demand is high, but the probability of purchase is low, the pricing engine may set the price lower than the competitor's prices to entice more customers to purchase the service. It can be seen from the above, that many different possibilities exist based on the data provided to the pricing engine 312.

In a further embodiment, the entity may tune the parameters, e.g., profit 308 and revenue 310, e.g., weighting one higher than the other in terms of importance, which is factored in by the pricing engine 312 to determine a price.

The application 120 may use business rules that apply a pricing recommendation value that defines the combined risk value, demand value, and probability of purchase value that is processed by the pricing engine 312. The business rules may be configured (and modified) to define ranges or limits of the amount or extent of risk, demand, and probability values. In an embodiment, the business rules may be configured such that if the pricing recommendation value meets or exceeds a threshold value defined, a respective customer who meets this criterion may be offered the corresponding service. Alternatively, when the recommendation value does not meet the threshold value, the service may not be offered to the customer.

In an embodiment, the application 120 is configured to monitor results of providing the service to the customers at the determined price. As shown in FIG. 3, the application 120 monitors 316 results (e.g., transaction histories associated with the customer with respect to the service at the determined price) to determine whether the risk was correctly assessed. In addition, the application 120 monitors 316 the number or quantity of customers that purchased the service (e.g., to determine whether the demand value and probability of purchase value were correctly assessed). The product pricing processes enable a closed loop learning mechanism that uses the results of the monitoring to re-establish the risk value, the demand value, and the likelihood of purchase value. As shown in FIG. 3, the results of the monitoring are returned to the pricing engine 312.

An equation that may be used to implement the product pricing processes described herein may be represented as follows:

Rᵢⱼ (p) denotes the amount of financial risk of customer i using product j at price p

Dᵢⱼ (p) denotes the extent of demand of customer i for product j at price p

Lᵢⱼ (p) denotes the likelihood of customer i purchasing product j at price p

Aⱼ(p) denotes the unit profit of product j at price p

Bⱼ(p) denotes the unit revenue generated by product j at price p

Assume there are n potential customers, and m products. The problem is modeled as an constrained optimization of p

$$\begin{matrix}arg {max}_{w , ξ} & {\sum }_{i = 1}^{n} {\sum }_{j = 1}^{m} {L}_{ij} ( p ) {A}_{j} ( p ) + λ {L}_{ij} ( p ) {B}_{j} ( p ) \\ s . t . & {\sum }_{i = 1}^{n} {\sum }_{j = 1}^{m} {R}_{ij} ( p ) \leq {C}_{1} ; \\ & {\sum }_{i = 1}^{n} {\sum }_{j = 1}^{m} {D}_{ij} ( p ) \geq {C}_{2} .\end{matrix}$$

Technical effects include product pricing processes customized for customers with regard to financial products and services. The products and services may include, e.g., wealth management, checking and savings accounts, credit cards, wire and transfer services, merchant services, currencies exchange, and asset financing, to name a few. The embodiments include segmenting a customer base into groups of customers, whereby each group consists of customers having the same or similar predefined characteristics. The embodiments include evaluating customer profiles and historical data collected on customer banking activities and transactions, in view of externally acquired information, such as third party product pricing and real-time market information, and applying this information to a set of business rules that account for a financial institution's desired profits and/or revenues and risk tolerances to determine price points for providing services to customers. In this manner, each customer may conceivably be charged a different price for the same product.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A system, comprising:
a computer processing device;
an application executable by the computer processing device, the customer grouping module configured to implement:
classifying customers of an entity into groups based on commonly shared, predefined characteristics and common financial transaction activities conducted among the customers;
identifying services rendered to the customers and services available but not rendered to the customers;
for each customer in each of the groups, estimating a risk value associated with providing a service based on results of providing the service to other customers in the group;
determining availability of the service, and prices set for the service, by third-party entities;
comparing a price for the service set by the entity with the prices set by the third-party entities;
estimating a demand value for the service of the entity as a function of the availability of the service by the third-party entities, the prices set by the third-party entities for the service, financial transaction histories, customer profiles, and real-time market data; and
for each customer in each of the groups, estimating a probability that the customer will purchase the service based on the demand value, a profile of the customer, a transaction history of the customer, and price of the service offered by the third-party entities, and calculating a price for the service that is customized for the customer, as a function of the risk value, the demand value, and the probability of purchase, and in view of at least one of a target profit value and a target revenue value.

2. The system of claim 1, wherein the estimating a risk of providing the service includes performing a collective loss evaluation for customers in the corresponding group who have received the service.

3. The system of claim 1, wherein the classifying the customers further includes classifying the customers according to economic health data associated with the customers, the economic health data including at least one of:
customer account balance;
customer available credit;
customer ownership of assets;
credit score;
annual financial report; and
customer length of employment.

4. The system of claim 1, wherein the estimating a demand value factors in current economic health data.

5. The system of claim 1, the estimating a probability that the customer will purchase the service is further based on current economic health data.

6. The system of claim 1, wherein the calculating a price for the service further comprises applying a weight to the at least one of the target profit value, the target revenue value, and the risk value.
